(19) United States
(12) Patent Application Publication
(10) Pub. No.: US 2017/0031213 A1
(43) Pub. Date: Feb. 2, 2017

(54) LIQUID CRYSTAL DISPLAY

(71) Applicant: Samsung Display Co., Ltd., Yongin-si (KR)

(72) Inventor: Sun Young KWON, Seoul (KR)

(21) Appl. No.: 15/003,857

(22) Filed: Jan. 22, 2016

(30) Foreign Application Priority Data
Jul. 31, 2015 (KR) 10-2015-0108460

(51) Int. Cl. G02F 1/1337; G02F 1/1343; C09K 19/30; G02F 1/1333

(52) U.S. Cl. CPC G02F 1/133711; G02F 1/133345; G02F 1/134309; C09K 19/3003; C09K 2019/3004; C09K 2019/3009; C09K 2019/301; C09K 2019/3016

(57) ABSTRACT

A liquid crystal display including: a first insulation substrate; a first alignment layer disposed on the first insulation substrate; a second insulation substrate facing the first insulation substrate; a second alignment layer disposed on a surface of the second insulation substrate facing the first insulation substrate; and a liquid crystal layer including liquid crystal molecules and disposed between the first alignment layer and the second alignment layer, wherein the liquid crystal molecules include at least one of a first compound represented by Chemical Formula 1 and a second compound represented by Chemical Formula 2:

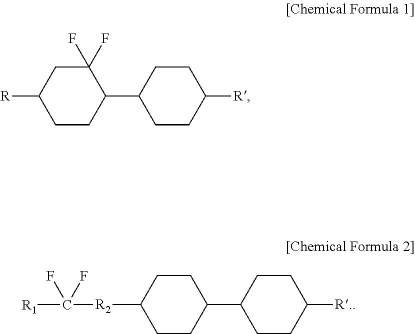

This application claims priority to and the benefit of Korean Patent Application No. 10-2015-0108460, filed on Jul. 31, 2015, and all the benefits accruing therefrom under 35 U.S.C. §119, the content of which in its entirety is herein incorporated by reference.

### BACKGROUND

(a) Field

The present invention relates to a liquid crystal display.

(b) Description of the Related Art

A liquid crystal display (LCD) is one of the most widely used flat panel displays. A liquid crystal display includes two display panels on which field generating electrodes are formed, and a liquid crystal layer interposed between the panels. In the liquid crystal display, voltages are applied to the field generating electrodes so as to generate an electric field over the liquid crystal layer and the alignment of liquid crystal molecules in the liquid crystal layer is determined by the electric field. Accordingly, the polarization of incident light is controlled thereby performing image display.

In the liquid crystal display, liquid crystals obtain a desired image by controlling the transmittance of light. In particular, depending upon the intended us of the liquid crystal display, various characteristics are required, such as low voltage driving, a high voltage holding ratio (VHR), a wide viewing angle characteristic, a wide range of operating temperature, and high speed response.

The above information disclosed in this Background section is only to enhance the understanding of the background of the invention and therefore it may contain information that does not form the prior art that is already known in this country to a person of ordinary skill in the art.

### SUMMARY

The present invention has been made in an effort to provide a liquid crystal display that has excellent response speed and transmittance.

An exemplary embodiment of the present invention provides a liquid crystal display including: a first insulation substrate; a first alignment layer disposed on the first insulation substrate; a second insulation substrate facing the first insulation substrate; a second alignment layer disposed on a surface of the second insulation substrate facing the first insulation substrate; and a liquid crystal layer including liquid crystal molecules and disposed between the first alignment layer and the second alignment layer, wherein at least one of the first alignment layer and the second alignment layer includes an alignment polymer, and the liquid crystal molecules include at least one of a first compound represented by Chemical Formula 1 and a second compound represented by Chemical Formula 2.

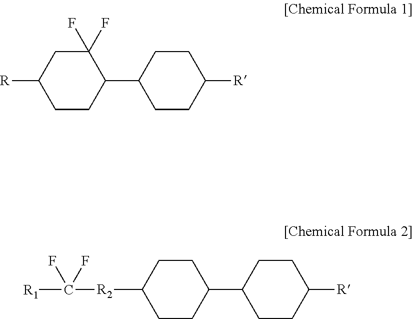

In Chemical Formula 1 and Chemical Formula 2, R, R′, and R₁, are independent of one another, a hydrogen, an alkyl group having 1 to 9 carbon atoms, an alkoxy group having 1 to 9 carbon atoms, or an alkenyl group having 2 to 9 carbon atoms; and R₂ is a bond, a divalent alkyl group having 1 to 9 carbon atoms, a divalent alkoxy group having 1 to 9 carbon atoms, or a divalent alkenyl group having 2 to 9 carbon atoms.

In an exemplary embodiment, the liquid crystal molecules may have a pretilt.

In an exemplary embodiment, the first compound may include at least one of the compounds represented by Chemical Formulas 1-1 to 1-5.

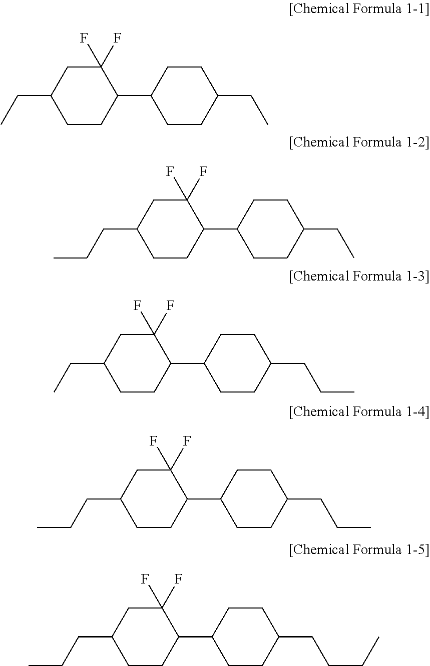

In an exemplary embodiment, the second compound may include at least one of the compounds represented by Chemical Formulas 2-1 to Chemical Formula 2-5.

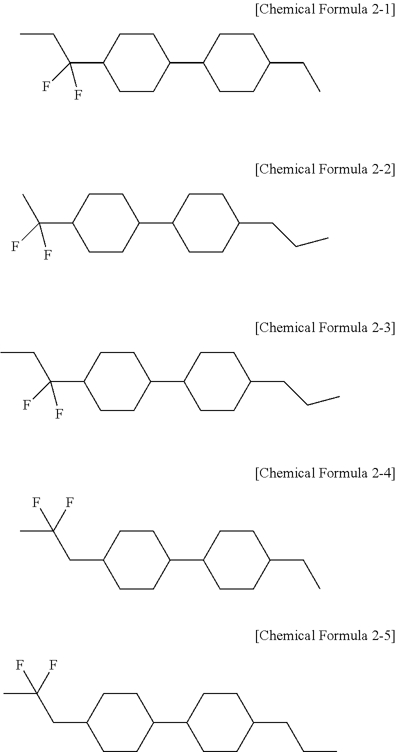

In an exemplary embodiment, the alignment polymer may include a polymerized alignment aid, the alignment aid including at least one of the third compounds represented by Chemical Formulas 3-1 to Chemical Formula 3-5.

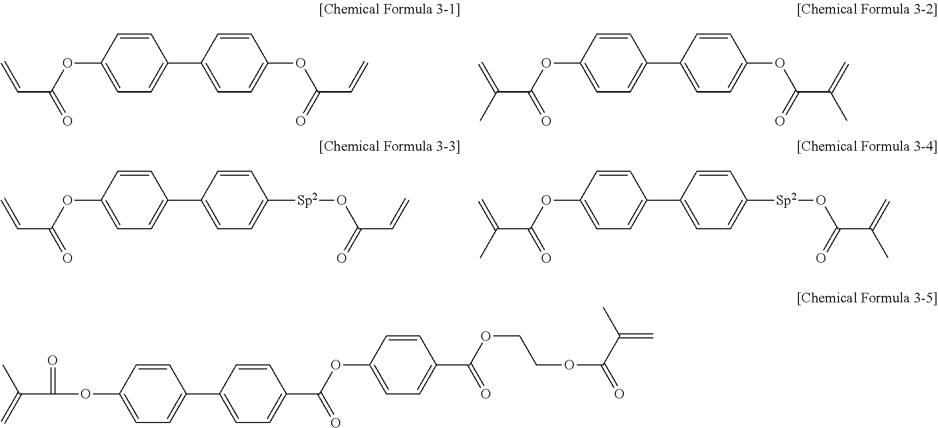

In Chemical Formulas 3-3 and Chemical Formula 3-4, the Sp² is an alkylene group having 2 to 5 carbon atoms.

In an exemplary embodiment, the liquid crystal molecules may include at least one of the fourth compounds represented by Chemical Formulas 4-1 to 4-13.

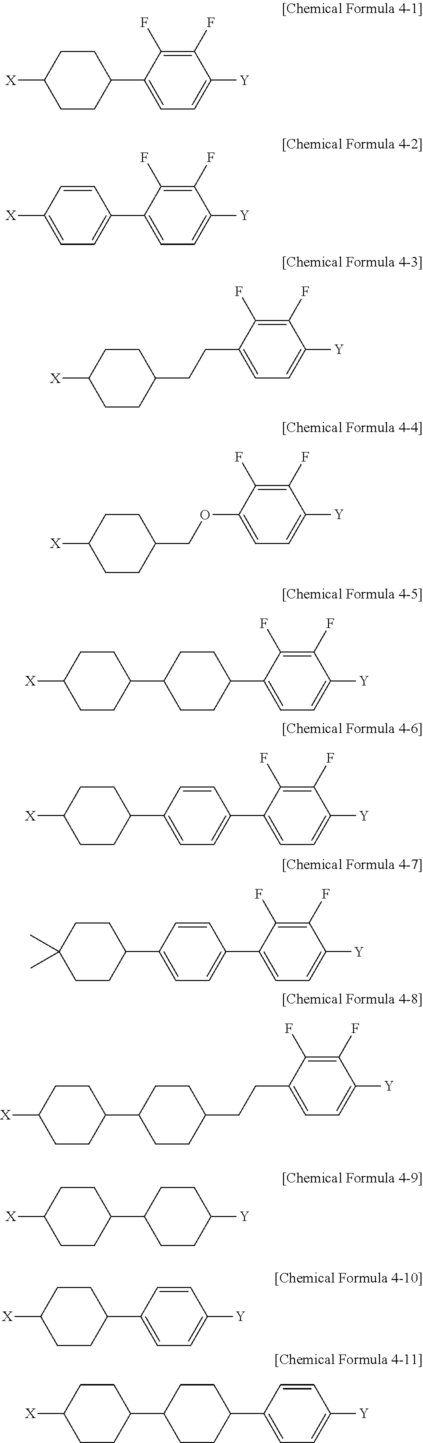

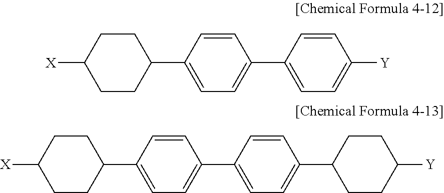

In Chemical Formulas 4-1 to 4-13, X and Y independently of one another, may be an alkyl group having 1 to 5 carbon atoms, an alkenyl group having 2 to 5 carbon atoms, or an alkoxy group having 1 to 5 carbon atoms, and wherein one or more hydrogen atoms (H) may be substituted by fluorine atoms (F).

In an exemplary embodiment, the fourth compound may be present in an amount of about 2 weight percent (wt %) to about 25 wt % based on the total weight of the liquid crystal molecules.

In an exemplary embodiment, the liquid crystal layer may have a negative dielectric anisotropy.

In an exemplary embodiment, the liquid crystal display may further include: a pixel electrode disposed on the first insulation substrate and connected to a thin film transistor, and a common electrode disposed on a surface of the second insulation substrate facing the first insulation substrate.

In an exemplary embodiment, the pixel electrode may include a cross-shaped stem and a minute branch extended from the cross-shaped stem.

Another exemplary embodiment of the present invention provides a liquid crystal display comprising: a first insulation substrate; a second insulation substrate facing the first insulation substrate; a field generating electrode disposed on at least one of the first insulation substrate and the second insulation substrate; and a liquid crystal layer including liquid crystal molecules and disposed between the first insulation substrate and the second insulation substrate, wherein the liquid crystal molecules include at least one of a first compound represented by Chemical Formula 1 and a second compound represented by Chemical Formula 2.

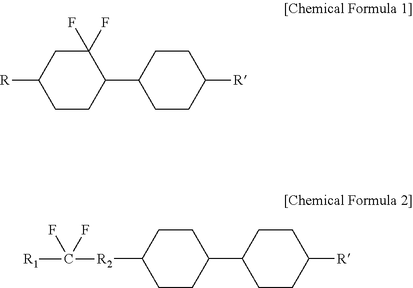

In Chemical Formula 1 and Chemical Formula 2, R, R′, and R₁, are independent of one another, a hydrogen, an alkyl group having 1 to 9 carbon atoms, an alkoxy group having 1 to 9 carbon atoms, or an alkenyl group having 2 to 9 carbon atoms; and R₂ is a bond, a divalent alkyl group having 1 to 9 carbon atoms, a divalent alkoxy group having 1 to 9 carbon atoms, or a divalent alkenyl group having 2 to 9 carbon atoms.

In an exemplary embodiment, the liquid crystal display may further include a first alignment layer disposed on the first insulation substrate; and a second alignment layer disposed on a surface of the second insulation substrate facing the first insulation substrate, wherein at least one of the first alignment layer and the second alignment layer may include an alignment polymer, and the liquid crystal molecules may have a pretilt due to the alignment polymer.

In an exemplary embodiment, the first compound may include at least one of the compounds represented by Chemical Formulas 1-1 to 1-5.

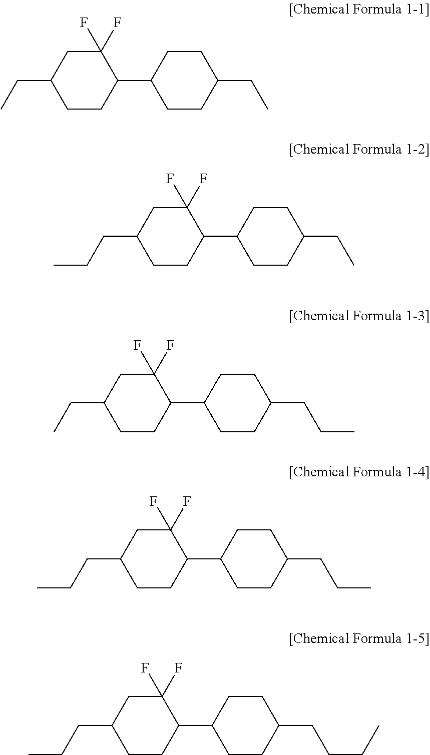

In an exemplary embodiment, the second compound may include at least one of the compounds represented by Chemical Formulas 2-1 to Chemical Formula 2-5.

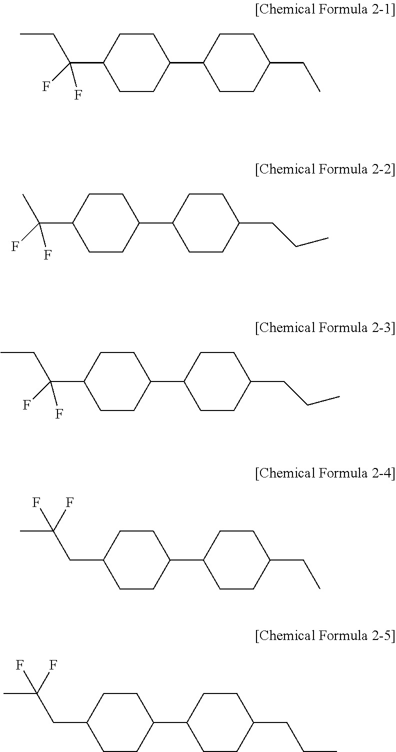

In an exemplary embodiment, the alignment polymer may be a polymerized alignment aid, the alignment aid including at least one of the third compounds represented by Chemical Formulas 3-1 to Chemical Formula 3-5.

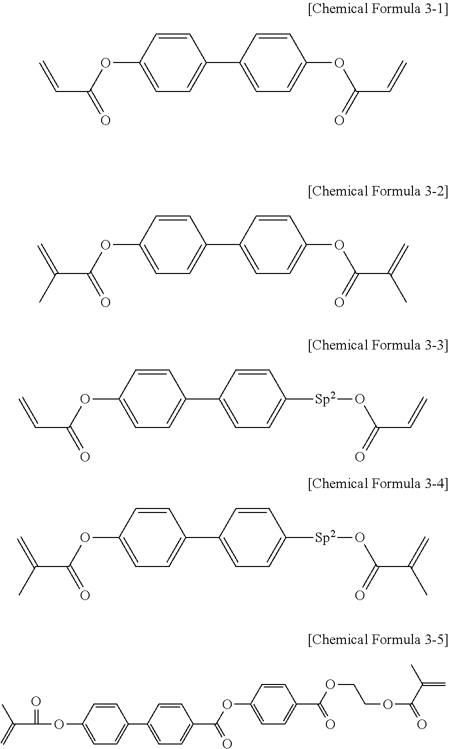

In Chemical Formulas 3-3 and Chemical Formula 3-4, Sp² is an alkylene group having 2 to 5 carbon atoms.

In an exemplary embodiment, the liquid crystal molecules may include at least one of the fourth compounds represented by Chemical Formulas 4-1 to 4-13.

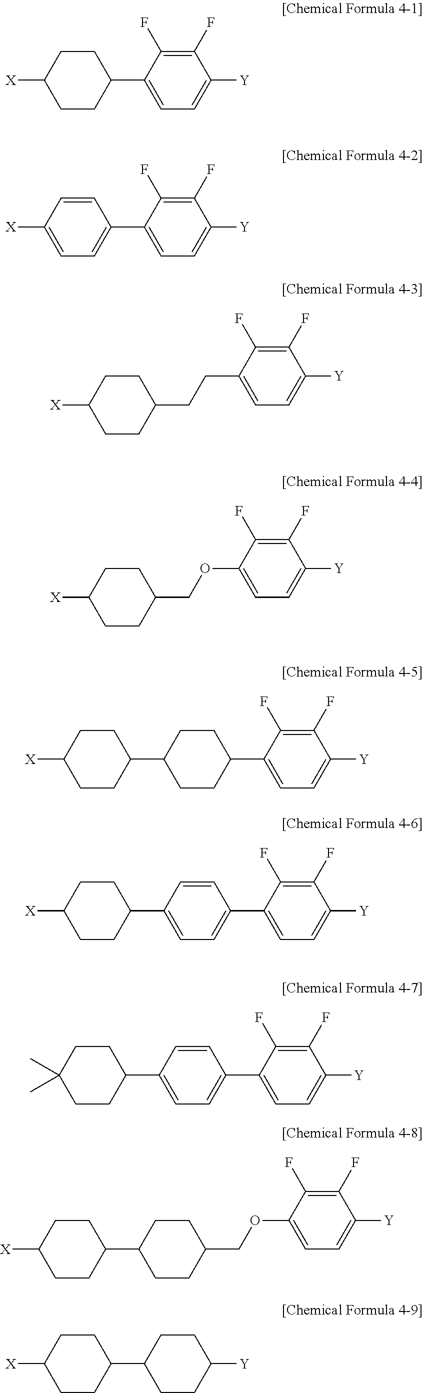

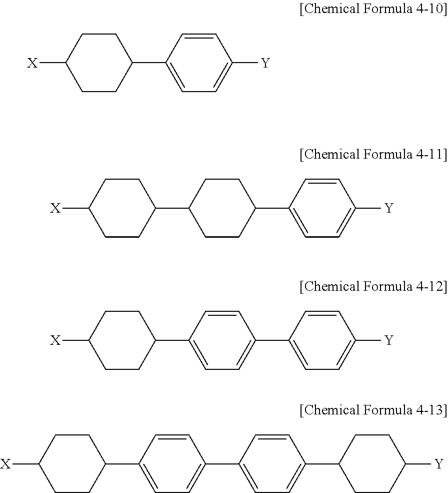

In Chemical Formulas 4-1 to 4-13, X and Y are, independent of one another, an alkyl group having 1 to 5 carbon atoms, an alkenyl group having 2 to 5 carbon atoms, or an alkoxy group having 1 to 5 carbon atoms, and wherein one or more hydrogen atoms in any of the foregoing groups may be replaced by, i.e., substituted by fluorine atoms.

In an exemplary embodiment, the fourth compound may be present in an amount of about 2 wt % to about 25 wt % based on the total weight of the liquid crystal molecules.

In an exemplary embodiment, the liquid crystal layer may have a negative dielectric anisotropy.

In an exemplary embodiment, the field generating electrode may include: a pixel electrode that is disposed on the first insulation substrate and is connected to a thin film transistor, and a common electrode disposed on a surface of the second insulation substrate facing the first insulation substrate.

In an exemplary embodiment, the pixel electrode may include a cross-shaped stem and a minute branch extended from the cross-shaped stem.

According to various embodiments, it is possible to improve response speed of a liquid crystal display by including a liquid crystal layer having a low rotational viscosity.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 illustrates a planar plan view of one pixel of an exemplary embodiment of a liquid crystal display.

FIG. 2 illustrates a cross-sectional view of FIG. 1 taken along line II-II.

FIG. 3 illustrates a top plan view of an exemplary embodiment of a basic pixel.

FIGS. 4 and 5 each illustrate a circuit diagram of one pixel of an exemplary embodiment of a liquid crystal display in which a structure of the thin film transistor in the exemplary embodiments illustrated in FIGS. 1 to 3 is modified.

### DETAILED DESCRIPTION

The present invention now will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

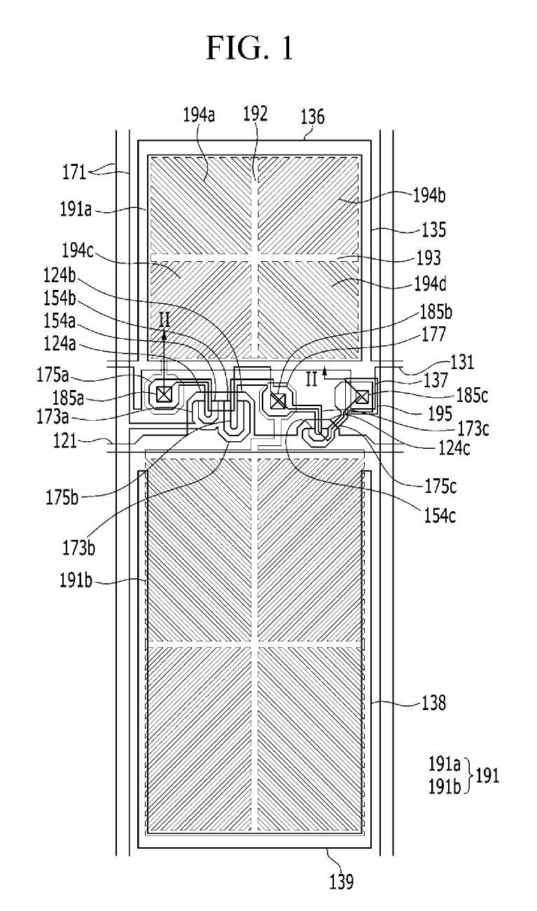

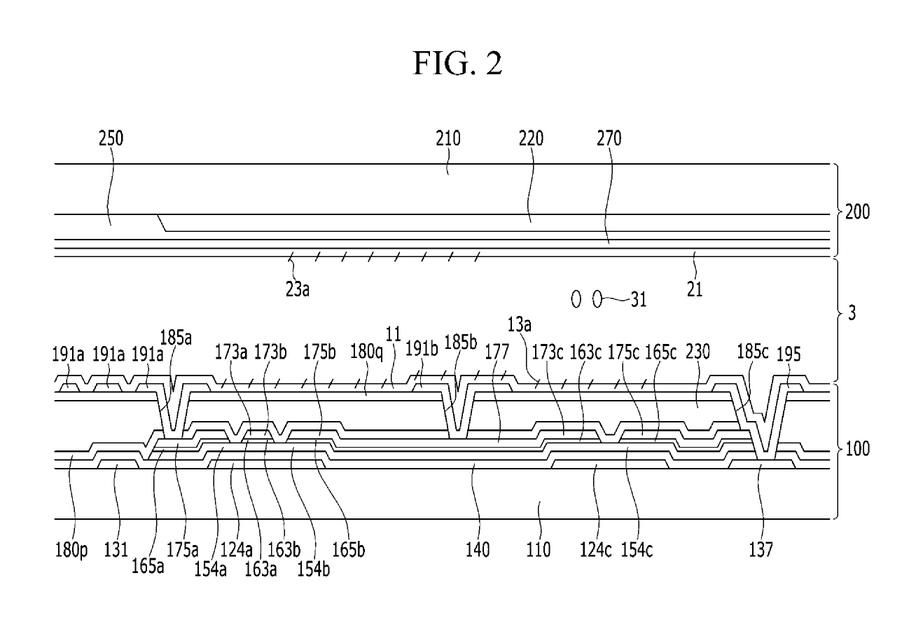

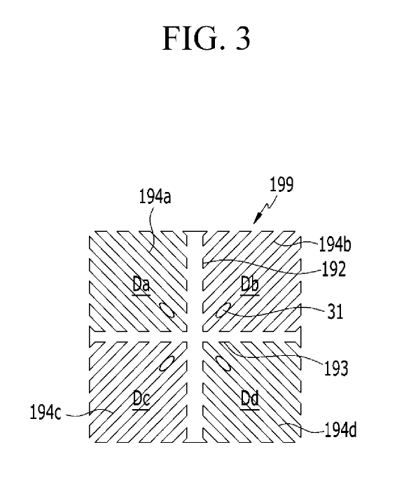

An exemplary embodiment of a liquid crystal display will now be described with reference to FIGS. 1 to 3. FIG. 1 illustrates a planar plan view of one pixel of an exemplary embodiment of a liquid crystal display, FIG. 2 illustrates a cross-sectional view of FIG. 1 taken along line II-II, and FIG. 3 illustrates a top plan view of a basic pixel.

First, an exemplary embodiment of a liquid crystal display includes a lower panel 100, an upper panel 200 that faces and is spaced apart from the lower panel 100, and a liquid crystal layer 3 disposed between the lower panel 100 and the upper panel 200.

In this case, liquid crystal layer 3 includes liquid crystal molecules 31, and an exemplary embodiment of the liquid crystal molecules forming liquid crystal layer 3 will now be described.

The liquid crystal molecules according to the exemplary embodiment of the present invention include at least one of a first compound represented by Chemical Formula 1 and a second compound represented by Chemical Formula 2.

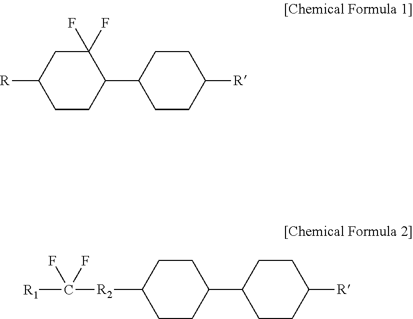

R, R′, and R₁, independent of one another, may be a hydrogen, an alkyl group having 1 to 9 carbon atoms, an alkoxy group having 1 to 9 carbon atoms, or an alkenyl group having 2 to 9 carbon atoms. R₂ may be a bond, a divalent alkyl group having 1 to 9 carbon atoms, a divalent alkoxy group having 1 to 9 carbon atoms, or a divalent alkenyl group having 2 to 9 carbon atoms

The first compound represented by Chemical Formula 1 may include at least one of the compounds represented by Chemical Formulas 1-1 to 1-5.

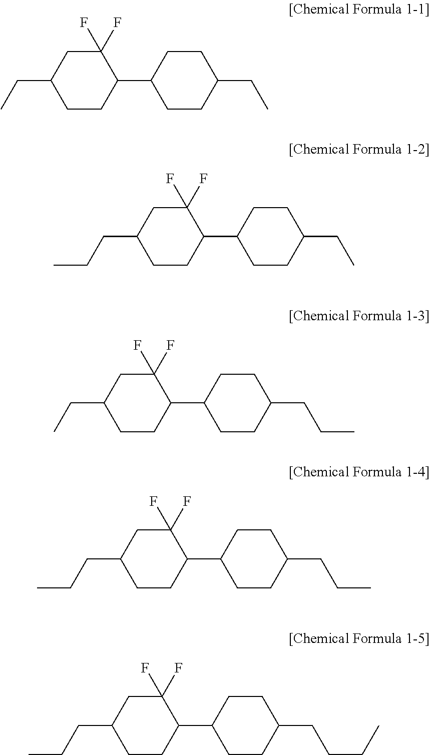

Further, the second compound represented by Chemical Formula 2 may include at least one of the compounds represented by Chemical Formulas 2-1 to 2-5.

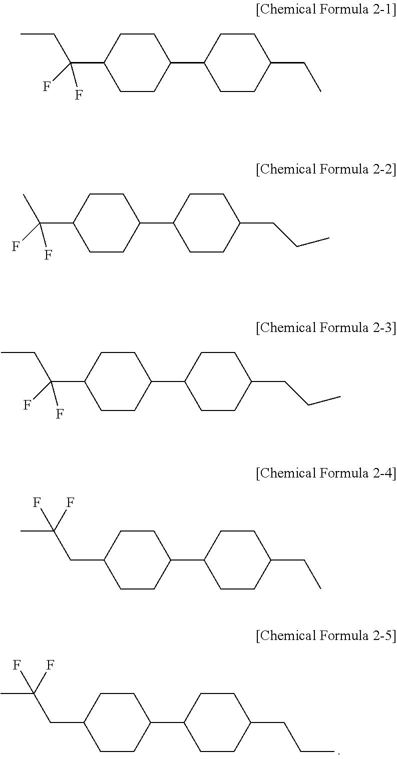

As such, the first compound represented by Chemical Formula 1 and the second compound represented by Chemical Formula 2 each include a bicyclohexyl group, have a low rotational viscosity, and may be used to form the liquid crystal layer.

In an exemplary embodiment, the liquid crystal molecules 31 may further include at least one of the fourth compounds represented by Chemical Formulas 4-1 to 4-13.

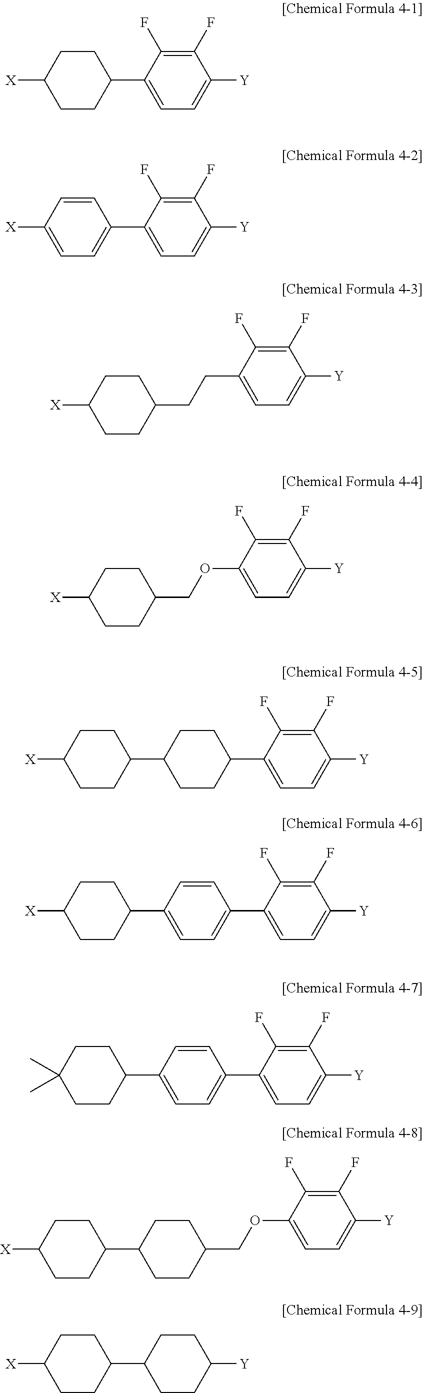

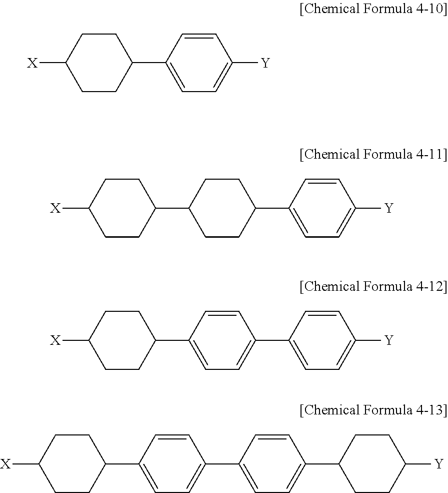

X and Y are, independent of one another, an alkyl group having 1 to 5 carbon atoms, an alkenyl group having 2 to 5 carbon atoms, or an alkoxy group having 1 to 5 carbon atoms, and one or more hydrogen atoms (H) may be fluorine atoms (F).

The fourth compound may be present in an amount of about 2 wt % to about 25 wt % based on the total weight of the liquid crystal molecules.

The above-described liquid crystal layer 3 has a negative dielectric anisotropy, and includes liquid crystal molecules with low rotational viscosity, thereby improving the response speed of the liquid crystal display.

Hereinafter, constituent elements of the liquid crystal display including the above-described liquid crystal layer will be described in detail with reference to FIGS. 1 to 3.

First, the lower panel 100 will be described.

A gate conductor including a gate line 121 and a divided voltage reference voltage line 131 is formed on an insulating substrate 110. The insulating substrate may be made of transparent glass, plastic, or the like.

The gate line 121 includes a first gate electrode 124a, a second gate electrode 124b, a third gate electrode 124c, and a wide end portion (not illustrated) for connection to another layer or an external driving circuit.

The divided voltage reference voltage line 131 includes first storage electrodes 135 and 136 and a reference electrode 137. Although second storage electrodes 138 and 139 are not connected to the divided voltage reference voltage line 131, they are disposed to overlap a second sub-pixel electrode 191b.

A gate insulating layer 140 is formed on the gate line 121 and the divided voltage reference voltage line 131.

A first semiconductor layer 154a, a second semiconductor layer 154b, and a third semiconductor layer 154c are disposed on the gate insulating layer 140. A plurality of ohmic contacts 163a, 165a, 163b, 165b, 163c, and 165c are disposed on the semiconductor layers 154a, 154b, and 154c.

A plurality of data lines 171 including a first source electrode 173a and a second source electrode 173b and a data conductor including a first drain electrode 175a, a second drain electrode 175b, a third source electrode 173c, and a third drain electrode 175c are disposed on the ohmic contacts 163a, 165a, 163b, 165b, 163c, and 165c and on the gate insulating layer 140.

The data conductor, the semiconductor disposed therebeneath, and the ohmic contacts may be simultaneously formed using a single mask.

The data line 171 includes a wide end portion (not shown) for connection to another layer or an external driving circuit.

The first gate electrode 124a, the first source electrode 173a, and the first drain electrode 175a form a first thin film transistor Qa along with the first semiconductor layer 154a, and a channel in the first thin film transistor is formed at the first semiconductor layer 154a between the first source electrode 173a and the first drain electrode 175a. Similarly, the second gate electrode 124b, the second source electrode 173b, and the second drain electrode 175b form a second thin film transistor Qb along with the second semiconductor layer 154b, and a channel in the second thin film transistor is formed at the second semiconductor layer 154b between the second source electrode 173b and the second drain electrode 175b. The third gate electrode 124c, the third source electrode 173c, and the third drain electrode 175c form a third thin film transistor Qc along with the third semiconductor layer 154c, and a channel in the third thin film transistor is formed at the third semiconductor layer 154c between the third source electrode 173c and the third drain electrode 175c.

The second drain electrode 175b is connected to the third source electrode 173c, and includes a wide expansion 177.

A first passivation layer 180p is disposed on the data conductors 171, 173c, 175a, 175b, and 175c and the exposed semiconductors layers 154a, 154b, and 154c. The first passivation layer 180p may be an inorganic insulting layer made of silicon nitride, silicon oxide, or the like. The first passivation layer 180p may prevent pigment from a color filter 230 from flowing into the exposed semiconductor layers 154a, 154b, and 154c.

A color filter 230 is disposed on the first passivation layer 180p. The color filter 230 is extended in a vertical direction along two adjacent data lines 171. Although the color filter 230 as illustrated in the exemplary embodiment of FIG. 2 is disposed at the lower panel 100, it is not limited thereto, and may alternatively be disposed at the upper panel 200.

A second passivation layer 180q is disposed on the color filter 230. Similar to the first passivation layer, the second passivation layer 180q may be an inorganic insulating layer such as a silicon nitride or a silicon oxide.

The second passivation layer 180q prevents peeling of the color filter 230 and suppresses contamination of the liquid crystal layer 3 by an organic material, such as a solvent flowing from the color filter 230, thereby preventing defects such as afterimages that may occur when an image is driven.

A first contact hole 185a and a second contact hole 185b are formed in the first passivation layer 180p and the second passivation layer 180q, and expose the first drain electrode 175a and the second drain electrode 185b, respectively.

A third contact hole 185c through which a portion of the reference electrode 137 and a portion of the third drain electrode 175c are exposed is formed in the first passivation layer 180p, the second passivation layer 180q, and the gate insulating layer 140. The third contact hole 185c is covered by a connecting member 195. The connecting member 195 electrically connects the reference electrode 137 and the third drain electrode 175c exposed through the third contact hole 185c.

A plurality of pixel electrodes 191 is disposed on the second passivation layer 180q. The respective pixel electrodes 191, which are one of the field generating electrodes, are separated from each other while the gate line 121 is interposed therebetween, and each of the pixel electrodes 191 includes a first sub-pixel electrode 191a and a second sub-pixel electrode 191b adjacent in a column direction based on the gate line 121.

The pixel electrode 191 may be made of a transparent material such as indium tin oxide (ITO) and indium zinc oxide (IZO), or a reflective metal such as aluminum, silver, chromium, or an alloy thereof

The first sub-pixel electrode 191a and the second sub-pixel electrode 191b each include a basic electrode as illustrated in FIG. 3, or one or more modifications thereof.

The first sub-pixel electrode 191a and the second sub-pixel electrode 191b are physically and electrically connected through the first contact hole 185a and the second contact hole 185b to the first drain electrode 175a and the second drain electrode 175b, respectively, and receive a data voltage from the first drain electrode 175a and the second drain electrode 175b. In this case, a portion of the data voltage applied to the second drain electrode 175b is divided through the third source electrode 173c, and thus a voltage applied to the first sub-pixel electrode 191a is greater than a voltage applied to the second sub-pixel electrode 191b.

The first sub-pixel electrode 191a and the second sub-pixel electrode 191b, to which the data voltage is applied, generate an electric field together with a common electrode 270 of the upper display panel 200 to determine a direction of the liquid crystal molecules in the liquid crystal layer 3 between two electrodes 191 and 270. The luminance of light passing through the liquid crystal layer 3 changes in accordance with the direction of the liquid crystal molecules.

A first alignment layer 11 is disposed on the pixel electrode 191, and the first alignment layer 11 may be a vertical alignment layer. The first alignment layer 11 may be formed to include at least one of the materials that are generally used as an alignment layer for liquid crystals, such as polyamic acid, polyimide, or the like.

The first alignment layer 11 is formed by coating an aligning agent including an alignment aid and irradiating light thereto. An alignment polymer 13a, formed by irradiating light to the alignment aid, is included in the first alignment layer 11. In this case, the alignment aid may be a reactive mesogen, and may include at least one of the third compounds represented by Chemical Formulas 3-1 to 3-5.

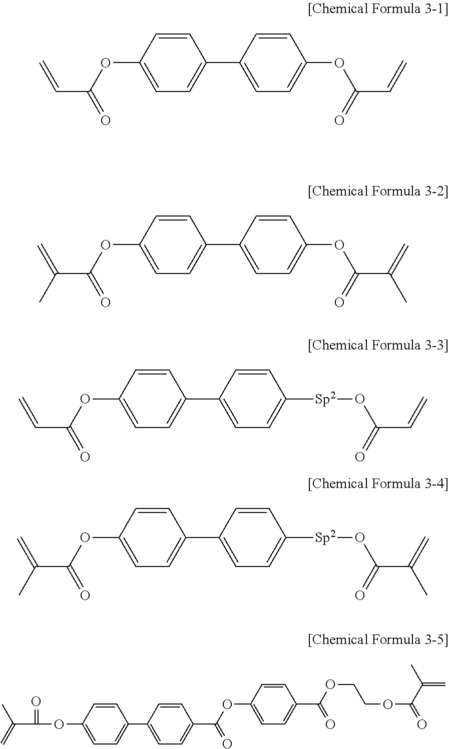

In Chemical Formulas 3-3 and 3-4, Sp² is a divalent alkylene group having 2 to 5 carbon atoms.

The alignment polymer 13a formed by polymerization of the alignment aid, allows the liquid crystal molecules 31 to have a pretilt, thereby improving the response speed and the transmittance of the liquid crystal layer.

Next, the upper panel 200 will be described.

A light blocking member 220 is disposed on a surface of second insulation substrate 210 facing the first insulation substrate 110. The light blocking member 220 is disposed on the upper panel 200 to overlap a region in which the data line 171 of the lower panel 100 is disposed and a region in which the thin film transistor is disposed. Although the light blocking member 220 is disposed on the upper panel 200 in FIG. 2, it is not limited thereto, and may alternatively be disposed on the lower panel 100.

Next, an overcoat 250 is disposed on a surface of the light blocking member 220 facing the first insulation substrate 110. The overcoat 250 is optional and may be omitted.

Next, the common electrode 270, which is one of the field generating electrodes, is disposed on a surface of the overcoat 250 facing the first insulation substrate 110. The common electrode 270 generates an electric field together with the pixel electrode 191 of the lower panel 100, and thus a direction of the liquid crystal molecules of the liquid crystal layer 3 between the electrodes 191 and 270 is determined.

A second alignment layer 21 is disposed on a surface of the common electrode 270 facing the first insulation substrate 110, and the second alignment layer 21 may be a vertical alignment layer. The second alignment layer 21 may be formed to include at least one material that is generally used as an alignment layer for the liquid crystals, such as, for example, polyamic acid, polyimide, or the like.

The second alignment layer 21 is formed by coating an aligning agent including an alignment aid and irradiating light thereto An alignment polymer 23a, formed by irradiating light to the alignment aid, may be included in the second alignment layer 21, and the alignment aid may be a reactive mesogen. For example, the alignment aid may include at least one of the third compounds represented by Chemical Formulas 3-1 to 3-5.

The liquid crystal layer 3 disposed between the first alignment layer 11 and the second alignment layer 21 has a negative dielectric constant, and since it is the same as the above-described liquid crystal layer, a detailed description thereof will be omitted.

A basic electrode 199 of the lower panel 100 will be described with reference to FIG. 3. Referring to FIGS. 1 to 3, each of the first and second sub-pixel electrodes 191a and 191b includes one basic electrode 199. For example, although the basic electrode is shown based on the first sub-pixel electrode 191a in FIG. 3, the basic electrode may be shown based on the second sub-pixel electrode 191b.

As shown in FIG. 3, the entire shape of the basic electrode 199 is quadrangular, and it includes a cross-shaped stem that is formed of a transverse stem 193 and a vertical stem 192 that is perpendicular thereto. In addition, the basic electrode 199 is divided into a first sub-region Da, a second sub-region Db, a third sub-region Dc, and a fourth sub-region Dd by the transverse stem 193 and the vertical stem 192. Each sub-region Da, Db, Dc, and Dd includes a plurality of first to fourth minute branches 194a, 194b, 194c, and 194d.

The first minute branch 194a obliquely extends from the transverse stem 193 or the longitudinal stem 192 in the upper-left direction, and the second minute branch 194b obliquely extends from the transverse stem 193 or the longitudinal stem 192 in the upper-right direction. The third minute branch 194c obliquely extends from the transverse stem 193 or the longitudinal stem 192 in the lower-left direction, and the fourth minute branch 194d obliquely extends from the transverse stem 193 or the longitudinal stem 192 in the lower-right direction.

The first to fourth fine branch portions 194a, 194b, 194c, and 194d form an angle of about 45° or 135° with the gate lines 121 or the horizontal stem portion 193. Further, the fine branch portions 194a, 194b, 194c, and 194d of the two adjacent sub-regions Da, Db, Dc, and Dd may be orthogonal to each other.

According to another exemplary embodiment, the widths of the fine branch portions 194a, 194b, 194c, and 194d may be increased as the fine branch portions become closer to the horizontal stem portion 193 or the vertical stem portion 192.

The first sub-pixel electrode 191a and the second sub-pixel electrode 191b are connected through the first contact hole 185a and the second contact hole 185b to the first drain electrode 175a or the second drain electrode 175b, and receive a data voltage from the first drain electrode 175a and the second drain electrode 175b.

In this case, sides of the first to fourth fine branch portions 194a, 194b, 194c, and 194d distort an electric field to generate a horizontal component which determines an inclination direction of the liquid crystal molecules 31. The horizontal components of the electric field are nearly horizontal to the sides of the first to fourth fine branch portions 194a, 194b, 194c, and 194d. Therefore, as shown in FIG. 3, the liquid crystal molecules 31 are inclined in a direction that is parallel to length directions of the fine branch portions 194a, 194b, 194c, and 194d. Since one pixel electrode 191 includes four sub-regions Da to Dd in which length directions of the fine branch portions 194a, 194b, 194c, and 194d are different from each other, there are about four directions in which the liquid crystal molecules 31 are inclined. Thus, four domains where the alignment directions of the liquid crystal molecules 31 are different from each other are formed in the liquid crystal layer 3. As described above, if the inclination directions of the liquid crystal molecules are diversified, a reference viewing angle of the liquid crystal display is increased.

The above description of the thin film transistor Q and the pixel electrode 191 are only an example, and thus the structure of the thin film transistor and the design of the pixel electrode may be variously modified to improve side visibility and the like.

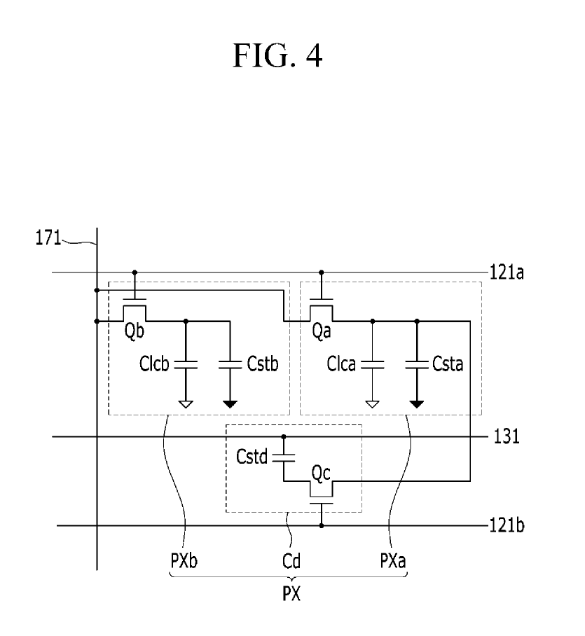

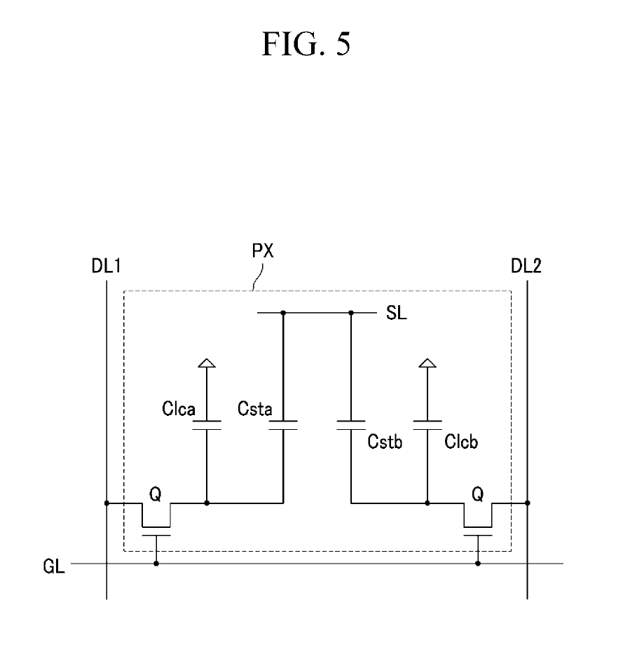

Hereinafter, disposition of a signal line and a pixel and a driving method of a liquid crystal display in which the structure of the above-described thin film transistor is modified will be described with reference to FIGS. 4 and 5. FIGS. 4 and 5 each illustrate a circuit diagram of one pixel of a liquid crystal display in which a structure of the exemplary embodiments of thin film transistors illustrated in FIGS. 1 to 3 is modified.

First, referring to FIG. 4, an exemplary embodiment of a liquid crystal display according includes signal lines including a gate line 121a, a step-down gate line 121b, a storage electrode line 131, and a data line 171 and a pixel PX connected thereto. The pixel PX includes a first sub-pixel PXa, a second sub-pixel PXb, and step-down part Cd.

The first sub-pixel PXa includes a first switching element Qa, a first liquid crystal capacitor Clca, and a first storage capacitor Csta, the second sub-pixel PXb includes a second switching element Qb, a second liquid crystal capacitor Clcb, and a second storage capacitor Cstb, and the step-down part Cd includes a third switching element Qc and a step-down capacitor Cstd.

The first and second switching elements Qa and Qb are three-terminal elements, such as thin film transistors provided to the lower panel, and they respectively include a control terminal connected to the gate line 121a, an input terminal connected to the data line 171, and an output terminal connected to the first and second liquid crystal capacitors Clca and Clcb and the first and second storage capacitors Csta and Cstb.

The third switching element Qc is a three-terminal element, such as a thin film transistor provided to the lower panel, and it includes a control terminal connected to the step-down gate line 121b, an input terminal connected to the first liquid crystal capacitor Clca, and an output terminal connected to the step-down capacitor Cstd.

The first and second liquid crystal capacitors Clca and Clcb are formed when the first and second sub-pixel electrodes 191a and 191b, connected to the first and second switching elements Qa and Qb, overlap the common electrode of the upper panel. The first and second storage capacitors Csta and Cstb are formed when the storage electrode line 131 overlaps the first and second sub-pixel electrodes 191a and 191b.

The step-down capacitor Cstd is connected to the output terminal of the third switching element Qc and the storage electrode line 131, and the storage electrode line 131 provided to the lower panel overlaps the output terminal of the third switching element Qc with an insulator therebetween.

An operation of the liquid crystal display of the present exemplary embodiment will now be described.

When a gate-on voltage Von is applied to the gate line 121a, the first and second thin film transistors Qa and Qb connected thereto are turned on.

The data voltage of the data line 171 is applied to the first and second sub-pixel electrodes 191a and 191b through the turned on first and second switching elements Qa and Qb. The first and second liquid crystal capacitors Clca and Clcb are charged by a voltage difference between the common voltage (Vcom) of the common electrode 270 and the voltage at the first and second sub-pixel electrodes 191a and 191b so the first liquid crystal capacitor Clca and the second liquid crystal capacitor Clcb are charged with the same voltage. A gate-off voltage (Voff) is applied to the step-down gate line 121b.

When the gate-off voltage (Voff) is applied to the gate line 121a and the gate-on voltage (Von) is simultaneously applied to the step-down gate line 121b, the first and second switching elements Qa and Qb connected to the gate line 121a are turned off and the third switching element Qc is turned on. The charges of the first sub-pixel electrode 191a connected to the output terminal of the first switching element Qa flow to the step-down capacitor Cstd to drop the voltage of the first liquid crystal capacitor Clca.

Regarding the case in which the exemplary liquid crystal display is driven in frame inversion and a data voltage having a positive (+) polarity with respect to the common voltage (Vcom) is applied to the data line 171, negative (−) charges are gathered in the step-down capacitor Cstd after the previous frame is finished. In the present frame, when the third switching element Qc is turned on, positive (+) charges of the first sub-pixel electrode 191a flow in the step-down capacitor Cstd through the third switching element Qc so the positive (+) charges are gathered in the step-down capacitor Cstd and the voltage of the first liquid crystal capacitor Clca drops. In the next frame, as the third switching element Qc is turned on while the first subpixel electrode 191a is charged with negative (−) charges, the negative (−) charges of the first subpixel electrode 191a flow in the step-down capacitor Cstd so the negative (−) charges are gathered in the step-down capacitor Cstd and the voltage of the first liquid crystal capacitor Clca also drops.

As described above, in an exemplary embodiment, the charged voltage of the first liquid crystal capacitor Clca can always be lower than that of the second liquid crystal capacitor Clcb regardless of the polarity of the data voltage. Thus, the charged voltages of the first and second liquid crystal capacitors Clca and Clcb may be different from each other, thereby improving the lateral visibility of the liquid crystal display.

An exemplary embodiment of a driving method of the liquid crystal display will now be described with reference to FIG. 5.

An exemplary embodiment of a liquid crystal display includes signal lines including a plurality of gate lines GL, a plurality of data lines DL1 and DL2, and a plurality of voltage-dividing reference voltage lines SL and a plurality of pixels PX connected thereto. Each pixel PX includes a pair of first and second liquid crystal capacitors Clca and Clcb and first and second storage capacitors Csta and Cstb.

Each sub-pixel includes one liquid crystal capacitor and one storage capacitor and further includes one thin film transistor Q. The thin film transistors Q of the two sub-pixels in one pixel are connected to the same gate line GL, but are connected to different data lines DL1 and DL2. The different data lines DL1 and DL2 simultaneously apply different levels of data voltages so that the first and second liquid crystal capacitors Clca and Clcb of the two sub-pixels have different charging voltages. As a result, the side visibility of the liquid crystal display may be improved.

Although the driving method of the liquid crystal display is described with reference to the circuit diagrams of FIGS. 4 to 5, it is not limited thereto, and may be any driving method suitable for improving a viewing angle.

Hereinafter, response speeds of an exemplary embodiment of the liquid crystal layer will be described with reference to Examples 1 to 3 and Comparative Example 1. Each of the Examples and Comparative Example includes the following liquid crystal molecules.

TABLE 1
Example 1

| Chemical Formula | Content (wt %) |
|---|---|
| 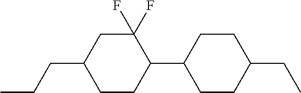 [SMILES: CCCC1CCC(C2CCC(CC)CC2)C(F)(F)C1] | 20 |
| 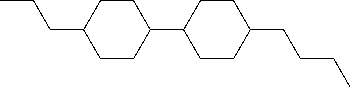 [SMILES: CCCCC1CCC(C2CCC(CCC)CC2)CC1] | 14 |
| 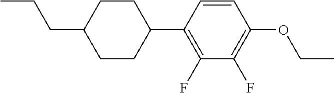 [SMILES: CCCC1CCC(c2ccc(OCC)c(F)c2F)CC1] | 22 |
| 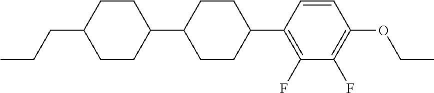 [SMILES: CCCC1CCC(C2CCC(c3ccc(OCC)c(F)c3F)CC2)CC1] | 22 |
| 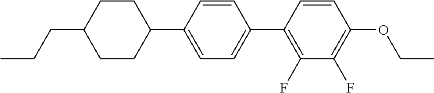 [SMILES: CCCC1CCC(c2ccc(-c3ccc(OCC)c(F)c3F)cc2)CC1] | 22 |

TABLE 2
Example 2

| Chemical Formula | Content (wt %) |
|---|---|
| 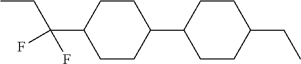 [SMILES: CCC1CCC(C2CCC(C(F)(F)CC)CC2)CC1] | 10 |
| 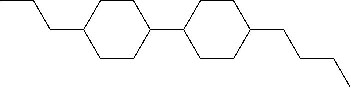 [SMILES: CCCCC1CCC(C2CCC(CCC)CC2)CC1] | 14 |
| 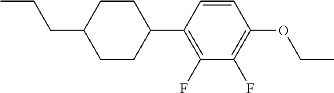 [SMILES: CCCC1CCC(c2ccc(OCC)c(F)c2F)CC1] | 22 |
| 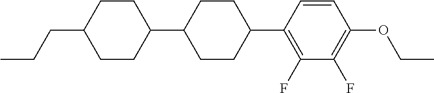 [SMILES: CCCC1CCC(C2CCC(c3ccc(OCC)c(F)c3F)CC2)CC1] | 22 |
| 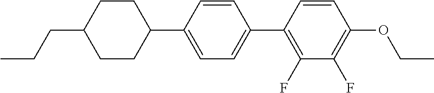 [SMILES: CCCC1CCC(c2ccc(-c3ccc(OCC)c(F)c3F)cc2)CC1] | 22 |
| 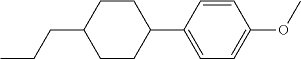 [SMILES: CCCC1CCC(c2ccc(OC)cc2)CC1] | 10 |

TABLE 3
Example 3

| Chemical Formula | Content (wt %) |
|---|---|
| 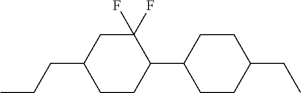 [SMILES: CCCC1CCC(C2CCC(CC)CC2)C(F)(F)C1] | 14 |
| 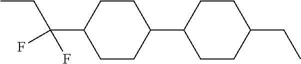 [SMILES: CCC1CCC(C2CCC(C(F)(F)CC)CC2)CC1] | 6 |
| 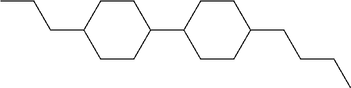 [SMILES: CCCCC1CCC(C2CCC(CCC)CC2)CC1] | 14 |
| 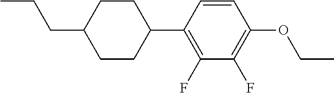 [SMILES: CCCC1CCC(c2ccc(OCC)c(F)c2F)CC1] | 22 |
| 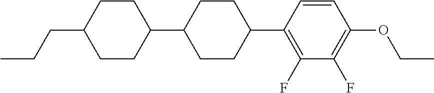 [SMILES: CCCC1CCC(C2CCC(c3ccc(OCC)c(F)c3F)CC2)CC1] | 22 |
| 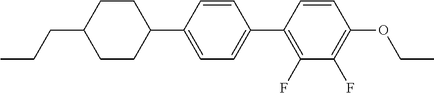 [SMILES: CCCC1CCC(c2ccc(-c3ccc(OCC)c(F)c3F)cc2)CC1] | 22 |

TABLE 4
Comparative Example 1

| Chemical Formula | Content (wt %) |
|---|---|
| 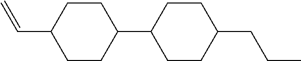 [SMILES: C=CC1CCC(C2CCC(CCC)CC2)CC1] | 20 |
| 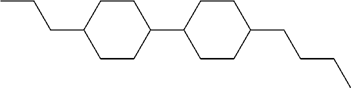 [SMILES: CCCCC1CCC(C2CCC(CCC)CC2)CC1] | 14 |
| 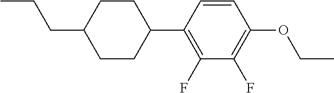 [SMILES: CCCC1CCC(c2ccc(OCC)c(F)c2F)CC1] | 22 |
| 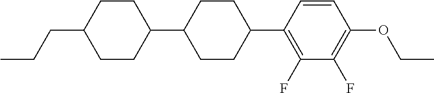 [SMILES: CCCC1CCC(C2CCC(c3ccc(OCC)c(F)c3F)CC2)CC1] | 22 |
| 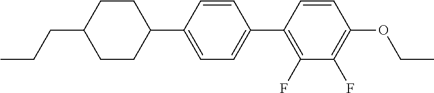 [SMILES: CCCC1CCC(c2ccc(-c3ccc(OCC)c(F)c3F)cc2)CC1] | 22 |

Example 1 includes the first compound represented by Chemical Formula 1-2, Example 2 includes the second compound represented by Chemical Formula 2-1, and Example 3 includes both the first compound represented by Chemical Formula 1-2 and the second compound represented by Chemical Formula 2-1. In contrast, Comparative Example 1 does not include either the first compound represented by Chemical Formula 1-2 or the second compound represented by Chemical Formula 2-1, but instead includes only typical (i.e. conventional) liquid crystal compounds.

Response speeds with respect to Examples 1 to 3 and Comparative Example 1 were measured. In this case, time T_{ON} was measured at about 12.4 milliseconds (ms) and time T_{OFF} was measured at about 8.1 ms for Example 1; time T_{ON} was measured at about 12.8 ms and time T_{OFF} was measured at about 7.7 ms for Example 2; time T_{ON} was measured at about 12.6 ms and time T_{OFF} was measured at about 8.0 ms for Example 3; and time T_{ON} was measured at about 13.2 ms and time T_{OFF} was measured at about 9.0 ms for Comparative Example 1.

That is, it can be seen that the liquid crystal compositions of Examples 1 to 3, including at least one of the first compound represented by Chemical Formula 1-2 and the second compound represented by Chemical Formula 2-1, have a faster and improved response speed as the Comparative Example.

The improved response speed depends on the inclusion of the first compound and the second compound including a bicyclohexyl group in the liquid crystal layer. The liquid crystal display including the first compound and the second compound may provide a better response speed even though a liquid crystal layer with a low rotational viscosity is applied.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a first insulation substrate;
a first alignment layer disposed on the first insulation substrate;
a second insulation substrate facing the first insulation substrate;
a second alignment layer disposed on a surface of the second insulation substrate facing the first insulation substrate; and
a liquid crystal layer comprising liquid crystal molecules and disposed between the first alignment layer and the second alignment layer,
wherein at least one of the first alignment layer and the second alignment layer comprises an alignment polymer, and
the liquid crystal molecules comprise at least one of a first compound represented by Chemical Formula 1 and a second compound represented by Chemical Formula 2: 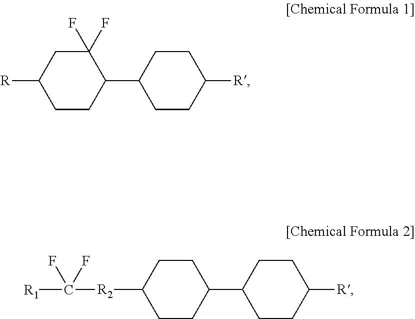
wherein, R, R′, and R₁, are, independent of one another, a hydrogen, an alkyl group having 1 to 9 carbon atoms, an alkoxy group having 1 to 9 carbon atoms, or an alkenyl group having 2 to 9 carbon atoms; and R₂ is a bond, a divalent alkyl group having 1 to 9 carbon atoms, a divalent alkoxy group having 1 to 9 carbon atoms, or a divalent alkenyl group having 2 to 9 carbon atoms.

2. The liquid crystal display of claim 1, wherein
the liquid crystal molecules have a pretilt due to the alignment polymer.

3. The liquid crystal display of claim 1, wherein
the first compound comprises at least one of compounds represented by Chemical Formulas 1-1 to 1-5:

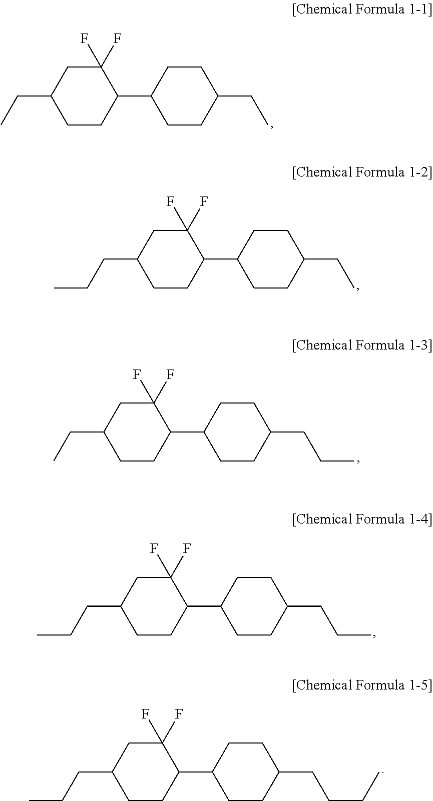

4. The liquid crystal display of claim 1, wherein
the second compound comprises at least one of compounds represented by Chemical Formulas 2-1 to Chemical Formula 2-5:

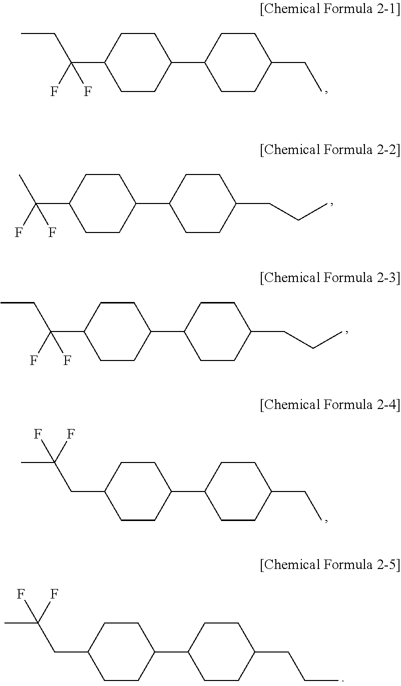

5. The liquid crystal display of claim 1, wherein
the alignment polymer is a polymerized alignment aid, the alignment aid comprising at least one of third compounds represented by Chemical Formulas 3-1 to Chemical Formula 3-5: 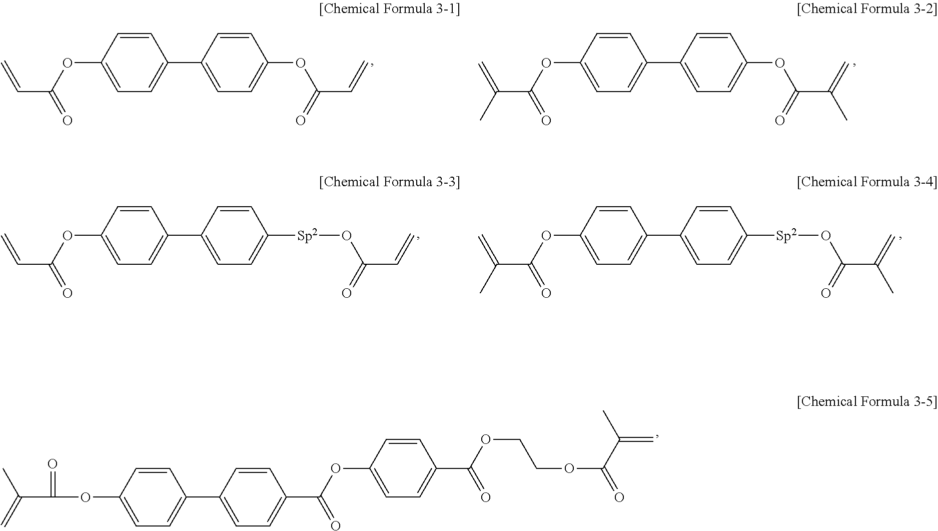
wherein, Sp² is an alkylene group having 2 to 5 carbon atoms.

6. The liquid crystal display of claim 1, wherein
the liquid crystal molecules further comprise at least one of fourth compounds represented by Chemical Formulas 4-1 to 4-13: 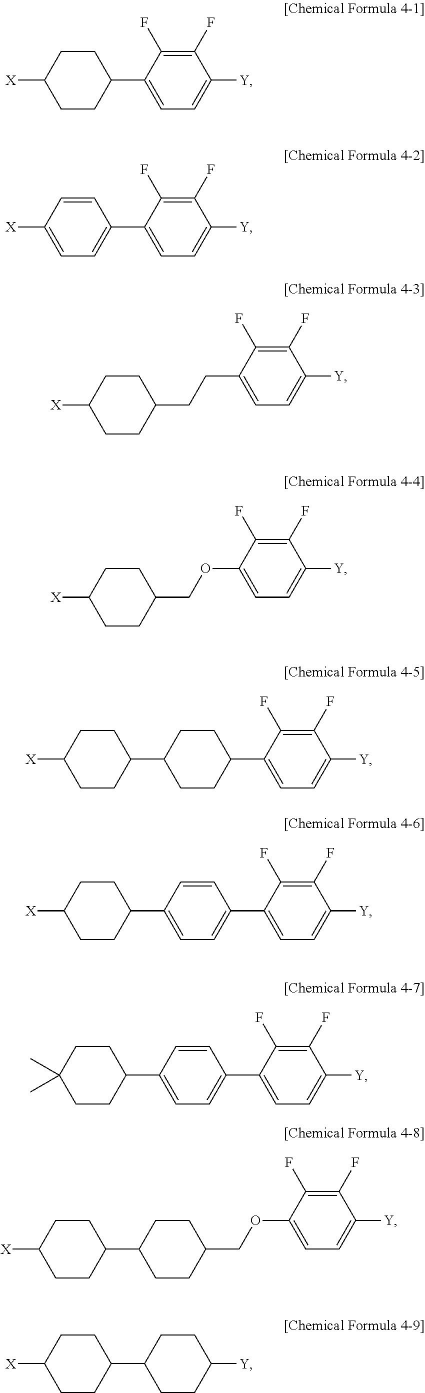 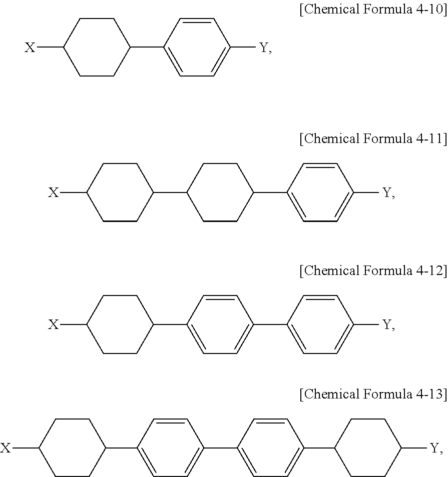
wherein, X and Y are, independent of one another, an alkyl group having 1 to 5 carbon atoms, an alkenyl group having 2 to 5 carbon atoms, or an alkoxy group having 1 to 5 carbon atoms, and wherein one or more hydrogen atoms are replaced by fluorine atoms.

7. The liquid crystal display of claim 6, wherein
the fourth compound is present in an amount of about 2 wt % to about 25 wt % based on the total weight of the liquid crystal molecules.

8. The liquid crystal display of claim 1, wherein
the liquid crystal layer has a negative dielectric anisotropy.

9. The liquid crystal display of claim 1, further comprising
a pixel electrode disposed on the first insulation substrate and connected to a thin film transistor, and
a common electrode disposed on a surface of the second insulation substrate facing the first insulation substrate.

10. The liquid crystal display of claim 9, wherein
the pixel electrode comprises a cross-shaped stem and a minute branch extended from the cross-shaped stem.

11. A liquid crystal display comprising:
a first insulation substrate;
a second insulation substrate facing the first insulation substrate;
a field generating electrode disposed on at least one of the first insulation substrate and the second insulation substrate; and
a liquid crystal layer comprising liquid crystal molecules and disposed between the first insulation substrate and the second insulation substrate,
wherein the liquid crystal molecules comprise at least one of a first compound represented by Chemical Formula 1 and a second compound represented by Chemical Formula 2: 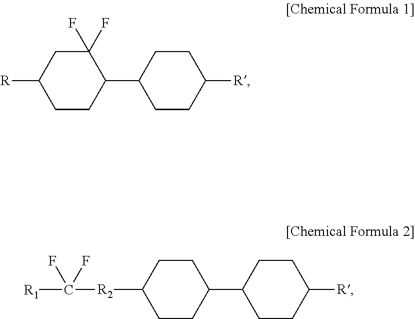
wherein R, R′, and R₁, are, independent of one another, a hydrogen, an alkyl group having 1 to 9 carbon atoms, an alkoxy group having 1 to 9 carbon atoms, or an alkenyl group having 2 to 9 carbon atoms; and R₂ is a bond, a divalent alkyl group having 1 to 9 carbon atoms, a divalent alkoxy group having 1 to 9 carbon atoms, or a divalent alkenyl group having 2 to 9 carbon atoms.

12. The liquid crystal display of claim 11, further comprising
a first alignment layer disposed on the first insulation substrate; and
a second alignment layer disposed on a surface of the second insulation substrate facing the first insulation substrate,
wherein at least one of the first alignment layer and the second alignment layer comprises an alignment polymer, and
the liquid crystal molecules have a pretilt due to the alignment polymer.

13. The liquid crystal display of claim 11, wherein
the first compound comprises at least one of compounds represented by Chemical Formulas 1-1 to 1-5:

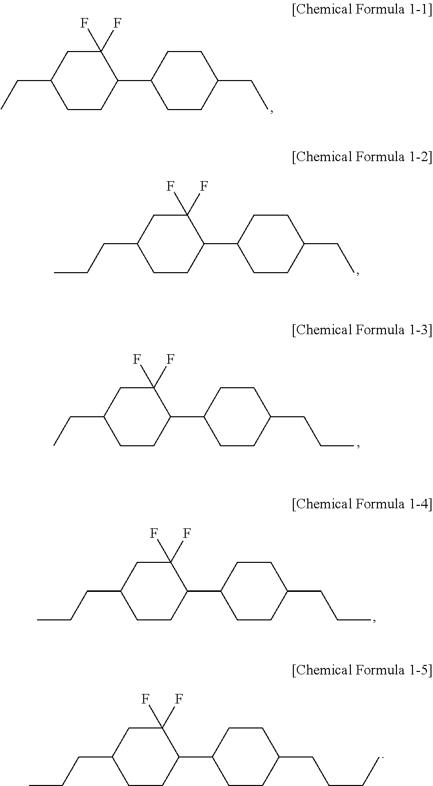

14. The liquid crystal display of claim 11, wherein
the second compound comprises at least one of compounds represented by Chemical Formulas 2-1 to Chemical Formula 2-5:

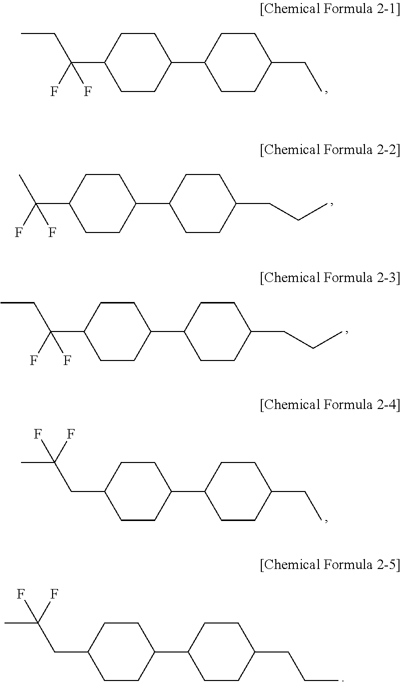

15. The liquid crystal display of claim 12, wherein
the alignment polymer is a polymerized alignment aid, the alignment aid comprising at least one of third compounds represented by Chemical Formulas 3-1 to Chemical Formula 3-5: 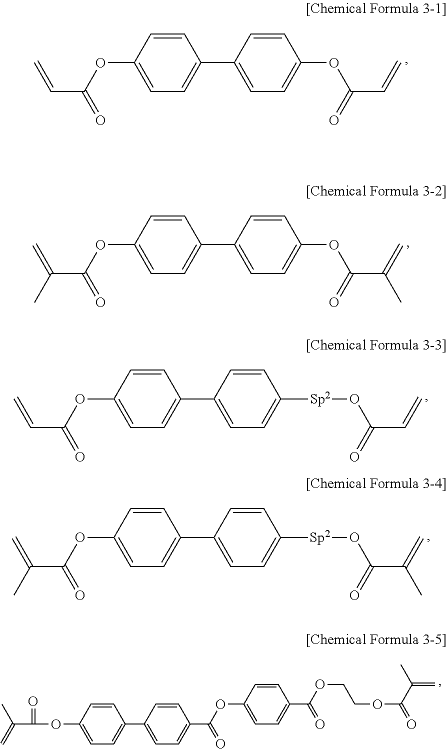
wherein, Sp² is an alkylene group having 2 to 5 carbon atoms.

16. The liquid crystal display of claim 11, wherein
the liquid crystal molecules further comprise at least one of fourth compounds represented by Chemical Formulas 4-1 to 4-13: 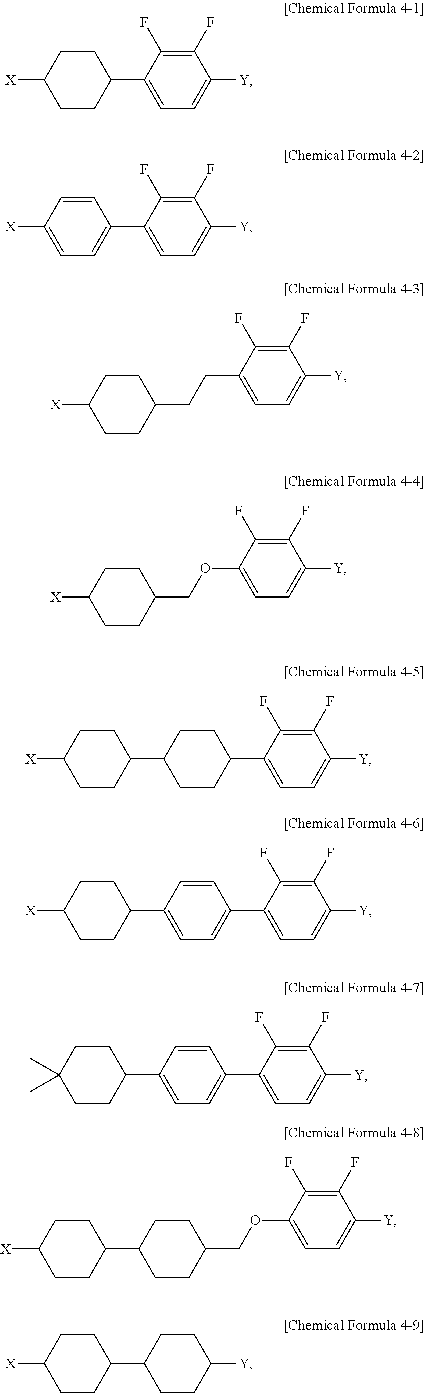 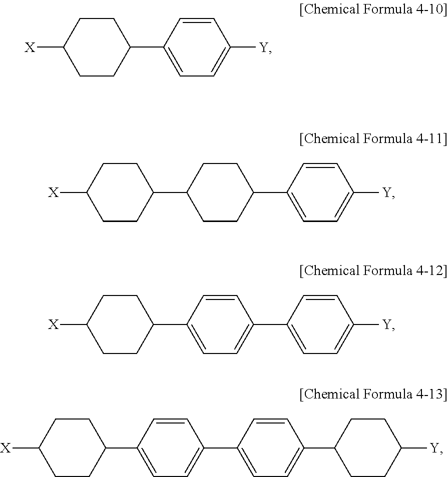
Wherein, X and Y are, independent of one another, an alkyl group having 1 to 5 carbon atoms, an alkenyl group having 2 to 5 carbon atoms, or an alkoxy group having 1 to 5 carbon atoms, and wherein one or more hydrogen are replaced by fluorine atoms.

17. The liquid crystal display of claim 16, wherein
the fourth compound is present in an amount of about 2 wt % to about 25 wt % based on the total weight of the liquid crystal molecules.

18. The liquid crystal display of claim 11, wherein
the liquid crystal layer has a negative dielectric anisotropy.

19. The liquid crystal display of claim 11, wherein
the field generating electrode comprises
a pixel electrode disposed on the first insulation substrate and connected to a thin film transistor, and
a common electrode disposed on a surface the second insulation substrate facing the first insulation substrate.

20. The liquid crystal display of claim 19, wherein
the pixel electrode comprises a cross-shaped stem and a minute branch extended from the cross-shaped stem.
